(19) United States
(12) Patent Application Publication
(10) Pub. No.: US 2013/0220933 A1
(43) Pub. Date: Aug. 29, 2013

(54) APPARATUS FOR THE USE OF NANOPARTICLES IN REMOVING CHEMICALS FROM AQUEOUS SOLUTIONS WITH SUBSEQUENT WATER PURIFICATION

(71) Applicants: William A. Farone, Irvine, CA (US); Shane L. Palmer, Coto De Caza, CA (US); Miguel Rivera, Orange, CA (US); Dwayne C. Chong, San Dimas, CA (US)

(72) Inventors: William A. Farone, Irvine, CA (US); Shane L. Palmer, Coto De Caza, CA (US); Miguel Rivera, Orange, CA (US); Dwayne C. Chong, San Dimas, CA (US)

(21) Appl. No.: 13/764,760

(22) Filed: Feb. 11, 2013

Related U.S. Application Data
(60) Provisional application No. 61/597,836, filed on Feb. 12, 2012.

(51) Int. Cl. C02F 1/28

(52) U.S. Cl. CPC C02F 1/28
USPC 210/663; 210/138; 210/194

(57) ABSTRACT

An apparatus for removing target chemicals from water includes a reaction chamber, a source of an aqueous solution of the target chemicals that can be supplied on demand to the reaction chamber, a timer that times a reaction between the particles and the target chemicals such that a concentration of the target chemicals in the aqueous solution reaches a predetermined low level in a desired time, and elements for removing the aqueous phase from the reactor while keeping the particles entrained inside the reactor using a microfilter configured to be back flushed, adding aqueous solution to the reactor from the source and continuing cycles until the particles are saturated, removing and replacing the particles in a final cycle of a particle charge lifetime, and recovering the target chemicals from the particles such that the particles can be reused.

### CROSS-REFERENCE TO RELATED APPLICATIONS

The present invention claims priority under 35 U.S.C. §119(e) of U.S. Provisional Patent Application No. 61/597,836, filed Feb. 12, 2012, entitled “APPARATUS FOR THE USE OF NANOPARTICLES IN REMOVING CHEMICALS FROM AQUEOUS SOLUTIONS WITH SUBSEQUENT WATER PURIFICATION,” the entire contents of which are incorporated herein by reference in their entirety.

### FIELD OF THE INVENTION

The present invention is directed to a water purification apparatus configured to use a wide variety of colloidal and nanoparticles to remove chemicals from water with subsequent purification of the water beyond the chemicals removed. More particularly, the apparatus collects the nanoparticles, or enables the nanoparticles to be easily collected, for recovery of the chemical such that the particles can be reused. The apparatus can accommodate a wide range of reaction times, particle and chemical concentrations and can be automated such that the apparatus operates in a fed batch mode to continuously purify the source aqueous solution.

### BACKGROUND OF THE INVENTION

The task of removing chemicals from aqueous solution, especially when they are present at low concentration, has been a commercial engineering problem for many years. This has been one of the main problems in making biotechnology commercially effective for a wide array of products. These problems commonly contribute to the high cost of remediating water contaminated with toxic materials or materials that could be recycled and reused if collected from the water.

In a chemical process, the separation and purification of the desired chemical in the aqueous phase can easily reach 40% of the cost of the chemical production even after all filterable solids are removed from the solution. The cost is higher the lower the concentration of produced chemical. In the process of removing a contaminant from water, it can be the bulk of the cost.

Conventionally, resin beds using absorbent resins are frequently used for chemical separations. In this technology, the highly filtered aqueous solution is pushed under pressure through a bed of resin wherein the resin adsorbs the chemical. The chemical is then washed off the bed by another solution in a more concentrated form. The flow through the bed must be uniform and precise and the system requires considerable hydraulic pressure. The resin beads are usually on the order of 100 micrometers or so and do not have the high surface area of a colloidal or nanoparticle bead. If the particles are made too small, the pressures needed may be excessive.

In the case of remediation technology, expensive resins are not usually the choice. Activated carbon filters commonly are used and the carbon with contaminant is collected and subsequently burned in hazardous waste incinerators.

The use of nanoparticles for the adsorption of chemicals has been proposed for many years. Although recently renamed “nanotechnology”, small particle chemistry has been known from the mid 19th century and in the 20th century these types of particle were included in the class of physical state covered by the discipline known as “colloid chemistry” or “colloid science”. By either name, a common difficulty has always been the manipulation of particles that are difficult to handle, difficult to see and collect, and potentially hazardous in their dry and dusty state. See, e.g., “Separation and purification techniques in biotechnology” by Frederick J. Dechow, Reed & Carnrick Pharmaceuticals, Piscatawy, N.J., Noyes Publications, Park Ridge, N.J., 1989; “Biochemical Engineering” by James M. Lee, Washington State University, Prentice hall, Englewood Cliffs, N.J., 1992; and “Separation, Recovery, and Purification in Biotechnology Recent Advances and Mathematical Modeling” by Juan A. Asenjo, EDITOR Columbia University, Juan Hong, EDITOR, Institute of Technology, Developed from a symposium sponsored by the Division of Microbial and Biochemical Technology at the 190th Meeting of the American Chemical Society, Chicago, Ill., Sep. 8-13, 1985, American Chemical Society, Washington, D.C. 1986, the entire contents of which are incorporated herein by reference in the entirety.

The higher surface area of such particles makes them a great candidate for improved separation and purification processes; however, their use has been extremely limited to date.

### SUMMARY OF THE INVENTION

These problems and others are addressed by the present invention, an exemplary embodiment of which comprises an apparatus that is configured to use a wide array of nanoparticles as adsorbent or absorbents. The apparatus allows for complete mixed contact with the aqueous solution being treated, allows for easy removal of the particles with no risk of the particles remaining in the purified water and provides for easy and continuous automated operation. The apparatus is also designed such that any level of purification of the water can be achieved including dissolved solids that are not collected by the particles but are still undesirable for using the water after removal of the target chemicals.

Exemplary embodiments of the apparatus can use solid particles made of a uniform substance or coated particles including, for example, particles with magnetic cores that have recently been described in the conventional art. Although the same apparatus or other exemplary apparatus can also handle larger particles, an exemplary embodiment is configured for particles in the range of smallest useful particles around 0.2 micrometers.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a schematic flow diagram illustrating an apparatus according to an exemplary embodiment of the invention.

FIG. 2 is a schematic flow diagram illustrating an apparatus according to another exemplary embodiment of the invention.

FIG. 3 is a schematic flow diagram illustrating an apparatus according to another exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

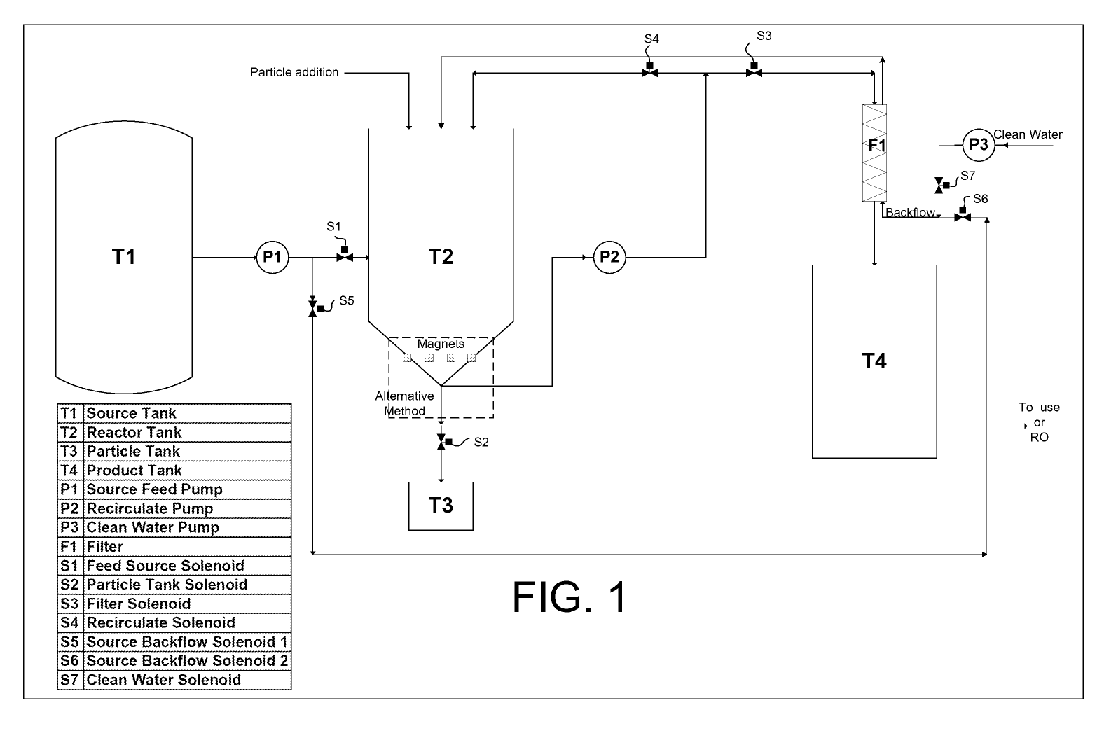

With reference to FIGS. 1-3, exemplary embodiments of a water purification apparatus configured to use a wide variety of colloidal and nanoparticles to remove chemicals from water with subsequent purification of the water beyond the chemicals removed, and method of water purification, will now be described.

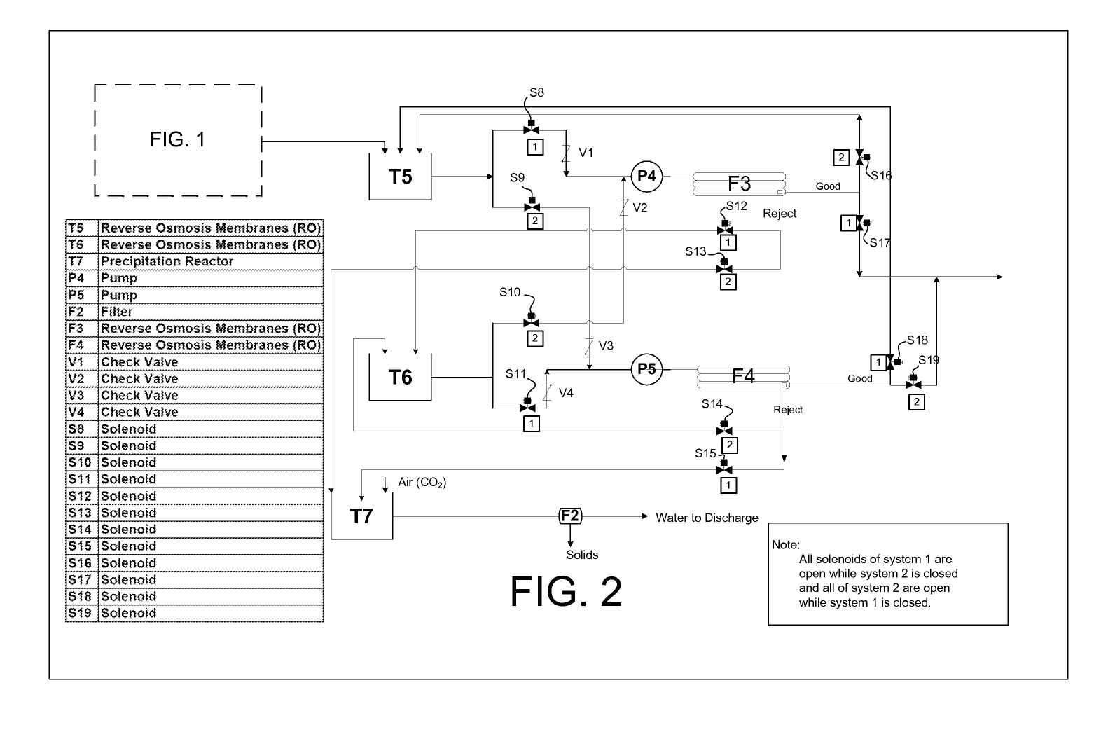

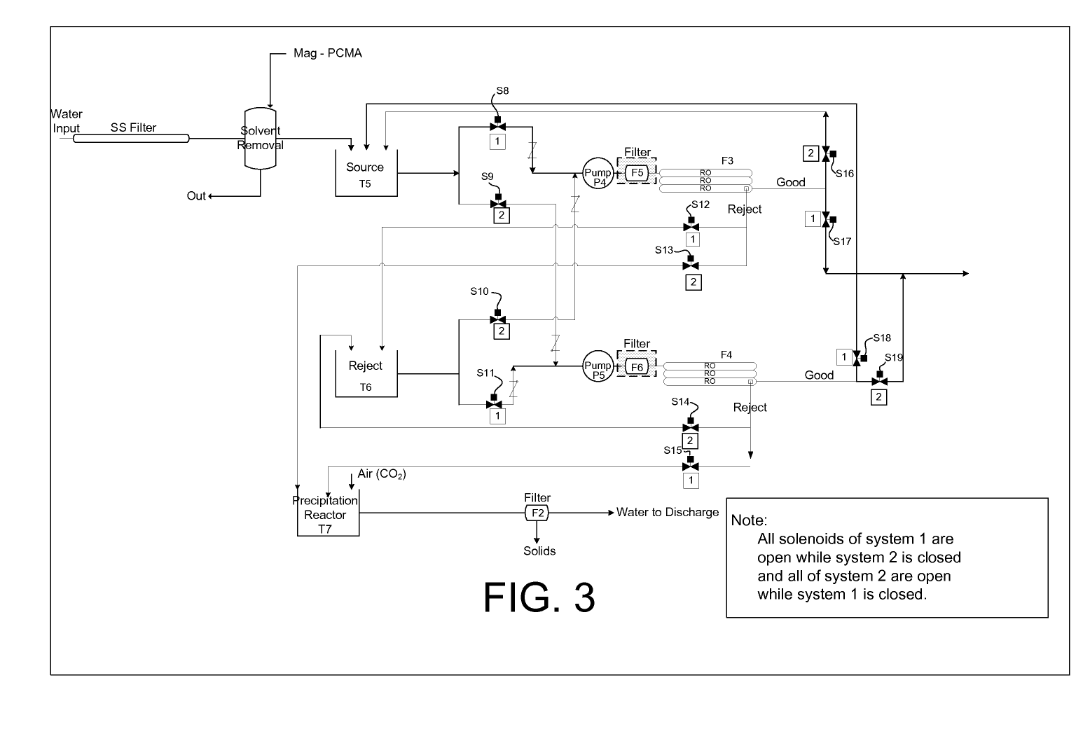

FIG. 1 illustrates an example of part of an exemplary embodiment of the apparatus that relates to handling the particles and removal of the chemical of interest. FIGS. 2 and 3 illustrate examples of another part of an exemplary embodiment of the apparatus that uses the produced water from FIG. 1 at the same required hydraulic flow to further purify the water for subsequent use. The example embodiments in FIGS. 1-3 can be used in combination with each other or separately on their own.

The particles or absorbents are designed to remove a known amount of the chemical of interest. The particles may be used several times before they are saturated and are removed to collect the chemical and either be reactivated or replaced with activated particles.

With reference to FIG. 1, an example of the flow for a single cycle before the replacement cycle is as follows.

The aqueous solution that contains the chemical of interest (target chemical or chemicals) is fed from Tank T1 through Pump P1 to solenoids (or valves) S1 and S5. When S1 is opened (S4 is closed), the aqueous solution flows into the treatment Tank T2. When S5 is opened (S1 is closed), the aqueous solution flows toward S6 where it can be used to back flush particles off Filter F1 to begin the next cycle of treatment. Since in the last cycle fresh water (water without the chemical of interest) will be used to flush the filters, S6 can be closed so that S7 can be opened and Pump P3 can be used to drive the particles back into T2.

In Tank T2, the aqueous solution with the target chemical or chemicals is reacted with the adsorbent particles for a predetermined period of time. In this example embodiment, the reactions time is based on the chemical kinetics of the adsorption process. The kinetics can be based on one or more of the design of the adsorbent, the concentration of the target chemical (or chemicals), the concentration of the adsorbent, the temperature and the mass transfer coefficient based on the mixing of the particles and the solution. A large advantage for this process occurs due to the fact that the mixing by circulation of the particles and the solution using Pump P2 with S4 open (S3 closed) confers a larger mass transfer (enhanced kinetics) over passing the solution through a bed of the same particles. Typical reaction times range from 1-2 minutes up to 45-60 minutes.

The kinetics can be based on the desired reduction in the concentration of the target chemicals in the aqueous solution. In a typical example, the initial concentration will range from a few milligrams per liter (mg/L) up to several percent in the solution and the final concentrations will be in the micrograms per liter (ng/L). For example, a contaminant in water may be 100 mg/L and it may be reduced to less than 5 ng/L to comply with water quality standards while a chemical produced by fermentation may be several percent in a solution and reduced to 10-50 mg/L during practical reaction times.

After the completion of a cycle achieving the desired reduction in the planned time, S4 is closed, S3 is opened, and the mixture flows through Filter F1 into product Tank T4. In an example, F1 can be a nanofilter or microfilter. In other examples, the filter materials can be fitted stainless steel or engineered plastic fiber. The pore size depends on the particles sizes. In the case of most nanoparticles, the pore size will be 0.1-0.2 μm typical of the size used for microbial filter sterilization.

The product in Tank T4 has been depleted of the target chemical or chemicals but there still may be other materials in the solution such as inorganic and organic ions comprising the total dissolved solids (TDS) of the solution that make the depleted solution unfit for higher value uses. The solution can then be treated according to the example embodiment described below.

After the last cycle, when the particles are saturated, the particles can be back flushed off the filter by using a small amount of clean water and collecting the particles in the bottom of Tank T2. To perform the final back flush, S7 is opened while S6 is closed. Pump P3 is used.

The final collection of particles can be augmented, for example, with “magnetic capture” in the case of adsorbent particles with a magnetic core. When it is desired to capture particles either after each cycle or at the end of a series of cycles leading to particle saturation, a magnet, or a series of electromagnets, can be activated. These will contain 60-99% of the particles such that the back flushing of F1 is much easier. In either case of collection of the particles after saturation, the particles can be recovered into Tank T3 by opening S2. A small amount of clean water can be used to flush Tank T3. The particles may be reactivated through removal of the target chemical by solvent extraction into a very concentrated, easily purified solution. The particles can then be added back to Tank T2.

Many contaminated water or aqueous streams from biological processes such as fermentation contain high levels of TDS and would not be usable in industrial or commercial applications even after the removal of the target chemicals. For example, industrial and commercial operations use a large amount of “cooling” water in cooling towers and other systems. Water from a process such as the manufacture of organic acids via fermentation would still not be suitable for use in a cooling tower even if all the product organic acid was removed.

With reference to the example illustrated in FIG. 2 (and similarly shown in the example illustrated in FIG. 3), the Tank 5 can receive as one stream the input water from Tank T4 in the example illustrated in FIG. 1. There are two coupled systems of solenoids in the example illustrated in FIG. 2. Solenoid System 1 contains solenoids S8, S10, S12, S15, S17 and S19. Solenoid System 2 contains solenoids S9, S11, S13, S14, S16 and S18. All solenoids of Solenoid System 1 are open when those of Solenoid System 2 are closed. All solenoids of Solenoid System 2 are open when those of Solenoid System 1 are closed.

When Solenoid System 1 is open the output of Tank T5 is pumped by Pump P4 into Reverse Osmosis Membranes (RO) F3. The produced water is directed as a portion of the total water product stream to the final use while the reject is directed to Tank T6. With Solenoid System 1 still open the water from Tank T6 is pumped by Pump P5 into Reverse Osmosis Membranes F4. The produced water is sent to Tank T5 and the reject water is sent to Tank T7 where calcium carbonate can precipitate when the calcium ion content of the total rejected water reaches 55 to 85 mg/L depending on the pH. This precipitation is enhanced as T7 is an open tank with mixing of carbon dioxide from the air which at pH above 7.8, preferably at 8.3, is enough in the carbonate form to cause precipitation. As shown in FIG. 3, an optional filter F5 can be provided between Pump P4 into Reverse Osmosis Membranes F3 and an optional filter F6 can be provided between Pump P5 and Reverse Osmosis Membranes F4.

The system is run in the above configuration for a short enough period of time (10-30 minutes depending on water quality) such that kinetics do not favor the precipitation of materials on the membranes in F4. After this period of time, Solenoid System 1 is closed and Solenoid System 2 is opened. This effectively switches the position of the two Reverse Osmosis Membrane modules to further protect the second set. The water from Tank T5 now flows through Pump P5 to F4. The high quality water produced at F4 is the other portion of the total water product stream while the reject goes to Tank T6. In this configuration, the water from T6 is fed by Pump P4 to F3. The produced water from F3 goes to Tank T5 while the reject goes to Tank T7. This completes the switching cycle wherein the next cycle can begin.

Since the water in T7 may contain solid precipitated calcium carbonate, the solids are collected by Filter F2 before the total reject is discharged.

The following are several, non-limiting examples of a process of using the exemplary embodiments illustrated in FIGS. 1-3.

In one example, the part of the apparatus diagrammed in FIG. 1 was operated with a methyl orange solution at a concentration of 100 mg/L to remove the methyl orange. Nanoparticles with a magnetic iron core and a silicate coating containing a positively charged ion when immersed in solution (3-(trimethoxysily)propyl-octadecyldimethyl-ammonium chloride) were used. The nanoparticles were designed to be able to remove 112 mg/L of methyl orange using a 5 gram/L concentration of particles in 45 minutes. It was determined that a concentration of 1.8 grams/L would remove 100 mg/L in less than two hours. Tank T2 was operated at a working volume of 10 Liters and 18 grams of particles were added. 10 liters of the methyl orange solution were sent to T2 and it was determined that the methyl orange was removed to non-detectable levels in 2 hours. The particles were collected for reuse. In this case, four (4) electromagnets were used to assist particle collection and they were able to collect 70% of the particles while F1 collected the remaining particles.

In an example, an apparatus according to the exemplary embodiments illustrated in FIGS. 2 and 3 was configured with the approximate flow rate through the system of 2 gallons per minute. Used water with a TDS of 800 mg/L was converted to water with 40 mg/L TDS with a reject of only 15% of the input water.

The example apparatus diagrammatically illustrated in FIG. 2 (and similarly in FIG. 3) was used with water of 400 mg/L. The purpose of this trial was to make water that contained less than 6 mg/L of TDS for use as very high quality reagent water. The system was used in dual pass mode (using the produced water from one pass to go through again) and water with <6 mg/L of TDS was obtained with 25% reject.

Exemplary Pilot Test

With reference again to FIGS. 1-3, an example of a pilot test conducted according to the invention will now be described.

To summarize, in this example pilot test, an exemplary treatment device according to the invention was used to remove 1,4-dioxane and 1,1-dichlorethene from water extracted from an active site. The test used 120 liters of water over 30 cycles of operation of the pilot equipment. The dioxane and DCE were both removed to non-detectable limits (<2 ppb) from the samples of water analyzed after 10, 20 and 30 cycles. The pilot unit can be scaled up and automated for testing at the site at an average flow of one gallon per minute.

Introduction of Pilot Test:

Previous laboratory tests conducted by Applicants had shown that the Ti-PCMA particles or the Fe-PCMA could remove DCE and dioxane. Based on previous small samples, a recognition and determination was made that a loading of 25 grams per liter of the particles should remove up to 100 ppb of DCE and 50 ppb of dioxane for at least 30 cycles of exposure of the particles to the contaminated water.

The exemplary laboratory pilot unit of the example treatment device has an approximately 5 gallon reactor and is set up corresponding to the attached diagram. The contaminated water is pumped into the reactor where it contacts the particles. The particles and water are circulated for a predetermined time to insure that the levels of the contaminants in the water fall below MCL. The water is then separated from the particles by a microporous filter and the particles returned to the reactor for the next aliquot of water to be treated.

A purpose of the tests using site water was to validate the laboratory findings about the kinetics and the cycle timing.

Results and Discussion of Pilot Test:

Samples of the site water were taken from drums that were received and tested for DCE and dioxane. The GC-MS analysis determined that the concentration of DCE was 39.5 ppb and dioxane was 57.9 ppb.

The test was begun by mixing 4 liters of the site water with 110 grams of the Ti-PCMA particles in the reactor. An extra 10% of particles was used to allow for some lack of total removal from the filter during subsequent filtration steps. Referring to FIGS. 1-3, pump P2 was then turned on and the mixture allowed to circulate from the tank through the pump P2 and back into the tank for 10 minutes. At this time the valves were changed such that pump P2 pumped the mixture through the filter F1. The produced water was collected in T4 and the first sample (zero time) was taken for analysis.

The filter used in this exemplary test was a sintered stainless steel hollow tube filter with a surface are of 365 cm² (0.0365 m²). The particles were collected on the outside of the filter between the filter surface and the housing. When the flow is reversed to push the particles back into the tank, the water flows through the center of the filter to the housing.

The lines in the laboratory unit are ¼″ tubing and the pump took 1.5 to 2 minutes to discharge into the filter. At this point P2 is stopped, P1 is turned on to backflush the particles from the filter back into the reactor. The valves are changed and the rest of the 4 liters is added from the source tank T1 to the reactor T2. The filling cycle is also 1.5 to 2 minutes. An entire cycle is therefore about 14 minutes making the average flow rate of this system 286 ml/minute. The flow rate of the two diaphragm pumps was 2 to 2.7 liters/minute.

This process was repeated 30 times with samples being taken after 10, 20 and 30 cycles. No DCE or dioxane was detected. The instrument had previously shown discernable peaks at levels of 1.7 and 1.9 ppb for these contaminants.

There was no observed degradation of the particles using these pumps over the course of the experiment. The actual longevity of the particles was not a part of this test.

Conclusions of Pilot Test:

After 30 cycles the levels of DCE and dioxane in the site water were reduced to below 2 ppb. The test was not run until exhaustion of the particles. Based on the previous laboratory studies, however, the present invention recognizes and estimates that 50 cycles will be possible before the particles have to be treated to remove and degrade the DCE and dioxane.

The present invention enables larger units to be built of various scales at, for example, 1 gpm, then 15 gpm, and then at any other larger size desired. For example, the present invention contemplates scaling the unit up to 1 gallon per minute (3.875 L/min) average flow. Assuming a 15 minute total time for a cycle and circulation of the reactor for 10 minutes, the present invention recognizes that a reasonable amount of time to fill and empty is 2 minutes. In an example, to average 1 gpm over the 15 minute period, the pumps must flow at 7.5 gpm (29 L/min) during the fill and empty cycles. The present invention can be scaled up to a continuous 1 gallon per minute unit, and then further to a 15 gallon per minute unit, and then to any other desirable larger size unit. In this way, the exemplary embodiments of the present invention enable the scaling of larger units from this arrangement.

The present invention recognizes that, in an example pilot test, the scale-up on flow is approximately 100 times but the scale up on the number of particles is only 15. The operating size of the reactor in this case can be 15 gallons compared to the approximate 1 gallon (4 liters in this test) in the pilot unit. In this example test, the filter was not limited in any way, and therefore, the present invention recognizes that a total filter surface of 10 times what was used in this example test should be adequate, which includes for example about 0.4 m². The implication for a full scale unit at 15 gpm would be that 4 m² of filter is a starting estimate. Experience with the automated system will show if the scale factor can be somewhat reduced. It should also be noted that the stainless steel filter is not the only choice. Other filters and materials such as polymeric microfilters have been provided in the same size range and have been used successfully in RO systems when precipitated CaCO₃ was to be eliminated from streams under 120 psi pressure going to the membranes. The smallest of these filters was too large for the laboratory unit but, based on price, one or more alternative filters may be appropriate for the filters for larger units.

To scale up the unit, the next task is to select the other components and program the control system for the solenoids. In an exemplary embodiment, the present invention uses PC technology with typical control boards to allow easy modification, reduce cost and provide for simple interfacing to any desired monitoring of the test unit and ultimately the full size unit.

In an exemplary embodiment, the source and produced water tanks are separate from the reactor unit.

The present invention made several assumptions in the example pilot tests. For example, the following are the current assumptions. The reactor tank will be 25 gallons to allow plenty of headspace and the potential for testing slightly increased rates. The system will be skid mounted on a doublewide skid. The system will be protected with the minimum of a roof and electrical connections will be available. Since the pumps are expected to be diaphragm pumps operating by a small air compressor, the total AC power will be determined by the requirements of the control system plus the compressor (to be determined).

The main unresolved part of the system in the removal of the particles (from T3 in FIGS. 1-3) and the introduction of fresh particles (from T5 in FIGS. 1-3). In the example, the frequency of the removal, treatment and recycling will determine the sizes of these tanks and solenoids. The total height of the unit is determined by the sum of T2, T5 and T3 assuming gravity feed for the system. Due to this becoming a factor as the system is scaled, the present invention recognizes that further conical bottom tanks for T5 and T2 with a width to height ratio of 3:1 may be a beneficial choice.

One of ordinary skill in the art will recognize that other tests can be performed based on, for example, the exemplary embodiments illustrated herein and the present invention is not limited to the exemplary pilot test described herein.

To summarize, the exemplary embodiments of the present invention can include an apparatus, and method of using the apparatus, that removes target chemicals from water using particles down to 0.2 micrometers in size. The apparatus can include (a) a source of an aqueous solution of the target chemical that can be supplied on demand to a reaction chamber, (b) a reaction chamber with means for adding and removing a slurry of particles. The reaction chamber also can include a device for recirculating the particles after mixing with the aqueous solution of the target chemical. The apparatus further includes (c) a device or component for timing the reaction between the particles and the target chemical such that the concentration of the target chemical in the aqueous solution reaches a predetermined low level in a desired time, (d) a device or component for removing the aqueous phase from the reactor while keeping the particles entrained inside the reactor using a microfilter that can be back flushed, (e) a device or component adding more aqueous solution to the reactor from the source and continuing the cycles until the particles are saturated, (f) a device or component for removing and replacing the particles in the final cycle of the particle charge lifetime, and (g) a device or component for recovering the target chemical from the particles such that the particles can be reused.

The apparatus can include one or more magnets that are installed to collect particles with magnetic cores in (d) and (f).

The microfilter back flushing during intermediate timed cycles before the final particle collection can be performed with source solution from the aqueous source containing the target chemical.

In an exemplary embodiment, the microfilter can be fitted stainless steel. In another exemplary embodiment, the microfilter can be formed polymeric material such that the flow of particles is along the center of the filter and the flow of collected water is radially out through the polymeric layer to collection of the water.

In an exemplary embodiment, the produced water from (d) flows into a dual stage reverse osmosis system wherein the reject from one stage is sent to a second stage and the stages are switched to coincide with the timing of the particle cycles in (d).

In an exemplary embodiment, the second stage reject water from the dual stages is combined with carbon dioxide from the air to react with calcium ions in the water to maintain acid-base balance and create calcium carbonate for disposal in the final reject water along with other ionic species that bind to calcium carbonate.

Another exemplary embodiments include a method of using the apparatus that removes target chemicals from water using particles down to 0.2 micrometers in size. The method includes (a) supplying a source of an aqueous solution of the target chemical on demand to a reaction chamber, (b) adding and removing a slurry of particles using a reaction chamber. The method can include recirculating, using the reaction chamber, the particles after mixing with the aqueous solution of the target chemical. The method further includes (c) timing the reaction between the particles and the target chemical such that the concentration of the target chemical in the aqueous solution reaches a predetermined low level in a desired time, (d) removing the aqueous phase from the reactor while keeping the particles entrained inside the reactor using a microfilter that can be back flushed, (e) adding more aqueous solution to the reactor from the source and continuing the cycles until the particles are saturated, (f) removing and replacing the particles in the final cycle of the particle charge lifetime, and (g) recovering the target chemical from the particles such that the particles can be reused.

The method can include magnetically collecting particles with magnetic cores in (d) and (f) using one or more magnets.

The microfilter back flushing during intermediate timed cycles before the final particle collection can be performed with source solution from the aqueous source containing the target chemical.

In an exemplary embodiment, the microfilter can be fitted stainless steel. In another exemplary embodiment, the microfilter can be formed polymeric material such that the flow of particles is along the center of the filter and the flow of collected water is radially out through the polymeric layer to collection of the water.

In an exemplary method, the produced water from (d) flows into a dual stage reverse osmosis system wherein the reject from one stage is sent to a second stage and the stages are switched to coincide with the timing of the particle cycles in (d).

In an exemplary method, the second stage reject water from the dual stages is combined with carbon dioxide from the air to react with calcium ions in the water to maintain acid-base balance and create calcium carbonate for disposal in the final reject water along with other ionic species that bind to calcium carbonate.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. An apparatus for removing target chemicals from water using particles down to 0.2 micrometers in size, the apparatus comprising:
a) a reaction chamber;
b) a source of an aqueous solution of target chemicals configured to be supplied on demand to the reaction chamber, the reaction chamber having means for adding and removing a slurry of particles, the reaction chamber having means for recirculating the particles after mixing with the aqueous solution of the target chemicals;
c) a timer that times a reaction between the particles and the target chemicals such that a concentration of the target chemicals in the aqueous solution reaches a predetermined low level in a desired time;
d) means for removing an aqueous phase from the reactor chamber while keeping the particles entrained inside the reactor chamber using a microfilter configured to be back flushed;
e) means for adding additional aqueous solution to the reactor chamber from the source and continuing cycles until the particles are saturated;
f) means for removing and replacing the particles in a final cycle of a particle charge lifetime; and
g) means for recovering the target chemicals from the particles such that the particles can be reused.

2. The apparatus of claim 1, wherein at least one of the means for removing the aqueous phase from the reactor chamber and the means for removing and replacing the particles in the final cycle comprises:
a magnet that collect particles with magnetic cores.

3. The apparatus of claim 1, wherein the microfilter back flushing during intermediate timed cycles before the final particle collection is performed with source solution from the aqueous source containing the target chemicals.

4. The apparatus of claim 1, wherein the microfilter comprises a fitted stainless steel microfilter.

5. The apparatus of claim 1, wherein the microfilter comprises a formed polymeric material such that a flow of particles is along a center of the microfilter and a flow of collected water is radially out through a polymeric layer to collection of the water.

6. The apparatus of claim 3, wherein the produced water from the means for removing the aqueous phase from the reactor chamber flows into a dual stage reverse osmosis system wherein a reject from a first stage is sent to a second stage and the first and second stages are switched to coincide with a timing of particle cycles in the means for removing the aqueous phase from the reactor chamber.

7. The apparatus of claim 6, wherein the second stage reject water from the dual stages is combined with carbon dioxide from air to react with calcium ions in the water to maintain acid-base balance and create calcium carbonate for disposal in a final reject water along with other ionic species that bind to calcium carbonate.

8. A method of removing target chemicals from water using particles down to 0.2 micrometers in size, the method comprising:
a) supplying a source of an aqueous solution of the target chemicals on demand to a reaction chamber;
b) adding and removing a slurry of particles using a reaction chamber, the reaction chamber having means for recirculating the particles after mixing with the aqueous solution of the target chemicals;
c) timing a reaction between the particles and the target chemicals such that a concentration of the target chemicals in the aqueous solution reaches a predetermined low level in a desired time;
d) removing an aqueous phase from the reactor chamber while keeping the particles entrained inside the reactor chamber using a microfilter configured to be back flushed;
e) adding additional aqueous solution to the reactor chamber from a source and continuing the cycles until the particles are saturated;
f) removing and replacing the particles in a final cycle of a particle charge lifetime; and
g) recovering the target chemicals from the particles such that the particles can be reused.

9. The method of claim 8, wherein the removing the aqueous phase from the reactor chamber and the removing and replacing the particles in the final cycle comprises:
magnets that collect particles with magnetic cores.

10. The method of claim 8, wherein the microfilter back flushing during intermediate timed cycles before the final particle collection is performed with source solution from the aqueous source containing the target chemicals.

11. The method of claim 8, where the microfilter comprises a fitted stainless steel microfilter.

12. The method of claim 8, wherein the microfilter comprises a formed polymeric material such that a flow of particles is along a center of the filter and a flow of collected water is radially out through a polymeric layer to collection of the water.

13. The method of claim 10, wherein the produced water from the removing the aqueous phase from the reactor chamber flows into a dual stage reverse osmosis system wherein the reject from one stage is sent to a second stage and the stages are switched to coincide with the timing of the particle cycles in the removing the aqueous phase from the reactor chamber.

14. The method of claim 13, wherein the second stage reject water from the dual stages is combined with carbon dioxide from the air to react with calcium ions in the water to maintain acid-base balance and create calcium carbonate for disposal in the final reject water along with other ionic species that bind to calcium carbonate.

15. An apparatus for removing target chemicals from water, the apparatus comprising:
a reaction chamber;
a source of an aqueous solution of the target chemicals that can be supplied on demand to the reaction chamber, the reaction chamber having means for adding and removing a slurry of particles, the reaction chamber having means for recirculating the particles after mixing with the aqueous solution of the target chemicals; and
a microfilter that removes the aqueous phase from the reactor while keeping the particles entrained inside the reactor, wherein the microfilter is configured to be back flushed.

16. The apparatus of claim 15, further comprising:
a timer that times a reaction between the particles and the target chemicals such that a concentration of the target chemicals in the aqueous solution reaches a predetermined low level in a desired time.

17. The apparatus of claim 15, further comprising:
means for adding more aqueous solution to the reactor from the source and continuing cycles until the particles are saturated.

18. The apparatus of claim 15, further comprising:
means for removing and replacing the particles in a final cycle of a particle charge lifetime.

19. The apparatus of claim 15, further comprising:
means for recovering the target chemicals from the particles such that the particles can be reused.

20. The apparatus of claim 15, wherein the particles include magnetic cores,
the apparatus further comprising a magnet that collects the particles.

21. The apparatus of claim 18, wherein the microfilter back flushing during intermediate timed cycles before the final particle collection is performed with source solution from the aqueous source containing the target chemicals.

22. The apparatus of claim 15, wherein the microfilter comprises a fritted stainless steel microfilter.

23. The apparatus of claim 15, wherein the microfilter comprises a formed polymeric material such that a flow of particles is along a center of the microfilter and a flow of collected water is radially out through a polymeric layer to collection of the water.

24. The apparatus of claim 15, wherein the produced water flows into a dual stage reverse osmosis system wherein a reject from a first stage is sent to a second stage and the first and second stages are switched to coincide with a timing of particle cycles.

25. The apparatus of claim 15, wherein a second stage reject water from the dual stages is combined with carbon dioxide from air to react with calcium ions in the water to maintain acid-base balance and create calcium carbonate for disposal in a final reject water along with other ionic species that bind to calcium carbonate.

26. The apparatus of claim 15, wherein a size of the particles is one of greater than and equal to 0.2 micrometers.

27. The apparatus of claim 15, wherein a size of the particles is substantially equal to 0.2 micrometers.
